(19) United States
(12) Patent Application Publication
(10) Pub. No.: US 2008/0267186 A1
(43) Pub. Date: Oct. 30, 2008

(54) Method to Transfer Data Packets From First Portable Source Endpoint Belonging to Moving Network to Second Destination Endpoint Belonging to Second, Preferably Packet Oriented Network

(76) Inventors: Konstantinos Boukis, Athens (GR); Jochen Eisl, Garching (DE); Louise Farr, Ipswich (GB)

Correspondence Address: STAAS & HALSEY LLP, SUITE 700, 1201 NEW YORK AVENUE, N.W., WASHINGTON, DC, 20005, US

(21) Appl. No.: 11/791,634

(22) PCT Filed: Nov. 11, 2005
(86) PCT No.: PCT/EP2005/055919

§ 371 Date: Apr. 18, 2008

(30) Foreign Application Priority Data
Dec. 1, 2004 (EP) 04257487.1

(51) Int. Cl. H04L 29/12

(52) U.S. Cl. 370/392

(57) ABSTRACT

Address translation is performed by a home domain of a first, e.g., mobile, network which may be moving relative to a second, e.g., packet oriented network, to convert the address of a first endpoint in the mobile network, associated with the home address of the first network to a second destination endpoint belonging to the second network.

### CROSS REFERENCE TO RELATED APPLICATIONS

This application is based on and hereby claims priority to European Application No. 04257487 filed on Dec. 1, 2004, the contents of which are hereby incorporated by reference.

### BACKGROUND

Described below is a method and an access point for transferring data packets from a first portable source endpoint belonging to a first, preferably mobile network to a second destination endpoint belonging to a second, preferably packet oriented network, wherein the first network may be moving relatively to the second network.

The method assigns addresses to nodes, which are connected to a moving network, i.e. a network, which can change location at some point in time.

It is presented a description of a concept for enabling hosts, such as notebooks, personal digital assistants (PDAs) and other network devices attached a moving network to initiate and maintain communications (such as TCP/IP or RTP/UDP connections) with other nodes on the Internet.

A moving network is a “network in motion”, that is a collection of portable nodes (PNs), which move together with (at least) one of them (the mobile router, MR) having a backhaul connection and thus providing the PNs with connection to the rest of the network. A group of moving nodes which commonly move with the same ground speed in the same direction constitute to a moving network. There is at least one gateway router, called mobile router here, which provides access for the contained client nodes (portable nodes) towards external networks. A correspondent node is reached through a transport network in the backhaul.

A Personal Area Network (PAN) in a car or a train network is imaginable such as a managed vehicular network (VN) to represent examples of moving networks. The architecture of a moving network includes one or more special gateway routers. Such a Mobile Router (MR) is enabled with a Mobility Protocol (e.g. Mobile IP (MIP)) to update location information for the moving network in external networks, e.g. network domains in the Internet and to facilitate handover procedures in case there are triggering events, such as movement, profile change etc. In addition to one or more MR there are a number of devices and user terminals that attain connectivity through the MR. The term portable node (PN) is used to refer to those devices, which can be carried y a user and may or may not support mobility, i.e. run a protocol for location updating and handover. However the method described here does not rely on this assumption. FIG. 1 illustrates the network topology, to which the method described below is applied.

The problem that has to be addressed is the mobility of the whole network. When the VN changes its point of attachment a mechanism must be applied so as to forward to the current location of the VN datagrams destined to nodes in it.

Prior-art mobility management protocols provide support for individual nodes. Extra functionality might be applied to those protocols for supporting networks with the drawback of modifications. The approach where all nodes within the VN are enabled with mobility functionality is not sophisticated since the amount for required location update signalling after handover depends on the number of portable nodes that require such mobility services from the network. Apart from that, the requirement for each PN running a mobility protocol, such as Mobile IP (MIP) eliminates the number of possible nodes that could be part on the VN, since there is no installed base of mobility protocols on PNs.

### SUMMARY

The method aims to overcome the above mentioned disadvantages.

A main aspect is a method for address translation performed by the home domain of the first moving network, wherein the address of a first endpoint is associated to the home address of the moving network. Further aspects are a mobile access point and a home access point to perform the above mentioned method.

The proposed algorithm provides support for both mobility aware and unaware nodes since the VN's mobility is hidden from he PNs. The IP address assigned to the PN remains unchanged through out the whole duration of the PN's connection to the VN. Additionally another problem that is tackled by the proposed mechanism is the handover from on VN to another, provided that the VNs are managed by the same operator.

The general concept of the method is to use address translation to associate PNs CoA (temporary address) with the MR home address(es). In the following Mobile IP (MIP) is mentioned, but this is an exemplification and in principle other mobility protocols/mechanisms could be taken into account as well. The translation is performed accordingly to a set of identifiers that are used to distinguish inbound and outbound packets and determine which address is used for translation. Translation enables network mobility to be supported without altering existing mobility mechanisms, such as the MIP protocol running on the MR or MR home agent, and further overcomes the addressing restrictions discussed previously. A key feature of the translation is that is uses information from an element external to the network address translator (NAT), i.e. information that is neither encoded within the IP packet header nor statically configured into the NAT unit.

It is assumed that the MR is MIP enabled which means that it has the ability-to maintain all ongoing sessions while changing its point of attachment to the Internet. MIP achieves its goals with the aid of a special router—the Home Agent (HA), which is situated in the home network of the mobile node. The network with network prefix matching that of the mobile node's home address. Packets destined to a MIP enabled node will be directed towards its home network with IP routing. Once within the home network, the packets are intercepted by the HA and tunnelled through to the current IP address (CoA) of the MIP enabled node. Tunnelling refers to the situation, where a packet is encapsulated at an ingress node and de-capsulated at an egress router to enforce the packet to travel on a fixed network path. Thus although MIP takes care of the delivery of packets from the MR home network to the MR care-of address, no support is provided for packets destined to nodes in the VN. This can be bypassed if address translation is performed on all packets generated from PNs in the VN. In every IP packet generated from the PNs the source address field is replaced by an MR home address, HoA. This results in response packets generated by correspondence nodes, CNs, to be destined to the same address (MR HoA) and consequently, with the aid of MIP, the packets are finally delivered to their final destination.

When a node connects to the VN it attains an IP address from the MR. Since this is a private address in principle it may not have to obey to any addressing restrictions imposed for routing packets in public networks. Different mechanisms can be employed for achieving this. One option is the dynamic allocation of an IP address for the PN e.g. through the use of Dynamic Host Configuration Protocol (DHCP). A different address allocation mechanism is associated with stateless auto-configuration like suggested for IPv6 networks. Any valid address space (which can be used for routing packets) can be used for providing addresses to hosts. This is a consequence of the address translation, which hides the real address of the hosts from other nodes on the Internet. More precisely the addresses assigned to the PNs are employed only for the communication which the VN. This gives a broader scope of possible addresses to allocate to PNs. Private addresses and MR subnet addresses are only one subset of the possible address range.

The major advantages of the proposed method are:
1. The mobility of a whole network is efficiently supported with only one node, the MR, enabled with mobility functionality. Subsequently the overhead of the messages necessary for mobility information update is much decreased compared with the case where all nodes are Mobile IP enabled and updates must be sent for every single one of them. Apart from that no modifications are required to the Mobile IP functionality.
2. Mobility transparency. More precisely the nodes in the VN are unaware of the VN's migration among ground networks.
3. For the method no special functionality is required from the nodes in the VN; all the necessary procedures are performed from home agent and network address translator in the MR home network domain.
4. Versatile addressing scheme. The address space from which addresses are assigned to nodes in the VN can be literally anything. Since address translation is performed the address that the CN sees is the MR's home address and not the address assigned from the VN to the nodes. For that reason any address space can be employed. This differs from the IETF approach where the address space assigned to the VN is a subnet of the MR's home network.
5. VN to VN handover with no action required from the PNs. As described in section 3 with minor modifications to the HA's functionality the PNs can migrate from one VN to another while keeping all ongoing sessions uninterrupted with the only modification the routing table update.
6. Furthermore this proposal works together with IPv4 as well as IPv6, and by no means is it bounded to any specific IP version.
7. Easy deployment. Address translation is processing-light task and as a result no restriction is put to the number of supported PNs.
8. The use of compression to the outgoing packets reduces the cost charged from the access network, in case where traffic is charged per byte.
9. The address translation mechanism can take into account information external to the IP-header, e.g. any kind of policy or state information and therefore influence traffic flow e.g. to optimize network utilization.
10. The mechanism can be used for PNs with and without mobility support. Those, which have an address allocated from the PN home network just by-pass the translation mechanism.

### BRIEF DESCRIPTION OF THE DRAWINGS

These and other objects and advantages will become more apparent and more readily appreciated from the following description of the preferred embodiments, taken in conjunction with the accompanying drawing in which:

FIG. 1 is a block diagram of the network topology to which is the method is applied,

FIG. 2 is a block diagram of a typical network topology in the case a vehicular network is connected with the home network domain via a mobile access point,

FIG. 3 is a block diagram of a typical network topology in the case a vehicular network is not connected with the home network domain,

FIG. 4 is a message flow diagram for a typical message flow between the source endpoint and the destination endpoint,

FIG. 5 is a block diagram of a typical network topology for mobility enabled endpoints,

FIG. 6 is a flow chart concerning the functionality of a home access point for packet processing of inbound traffic and

FIG. 7 is a flow chart concerning a packet analyzing process.

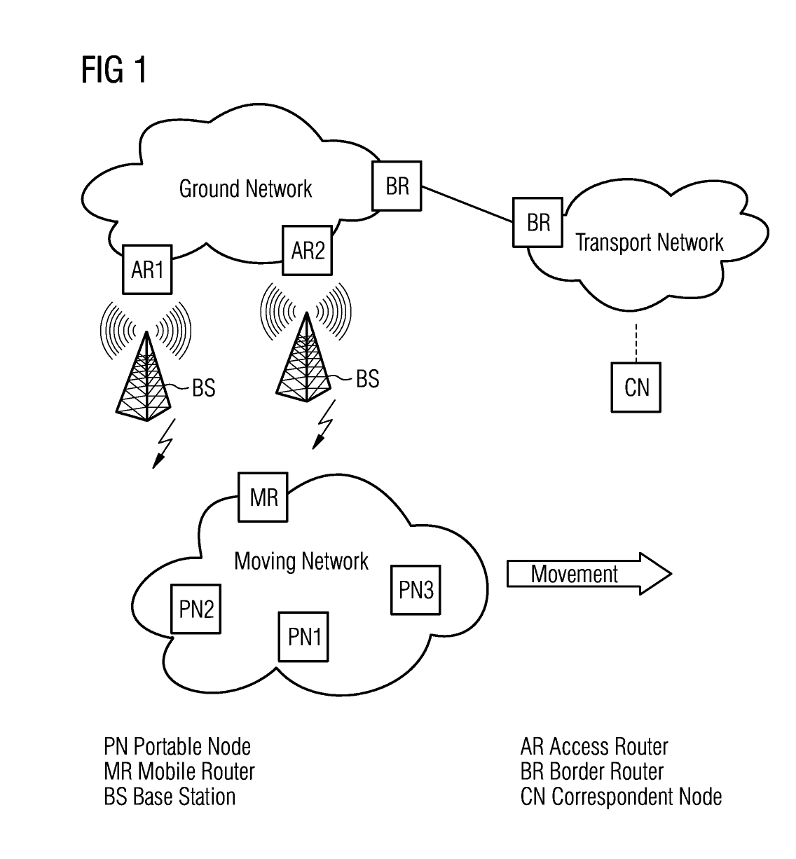

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

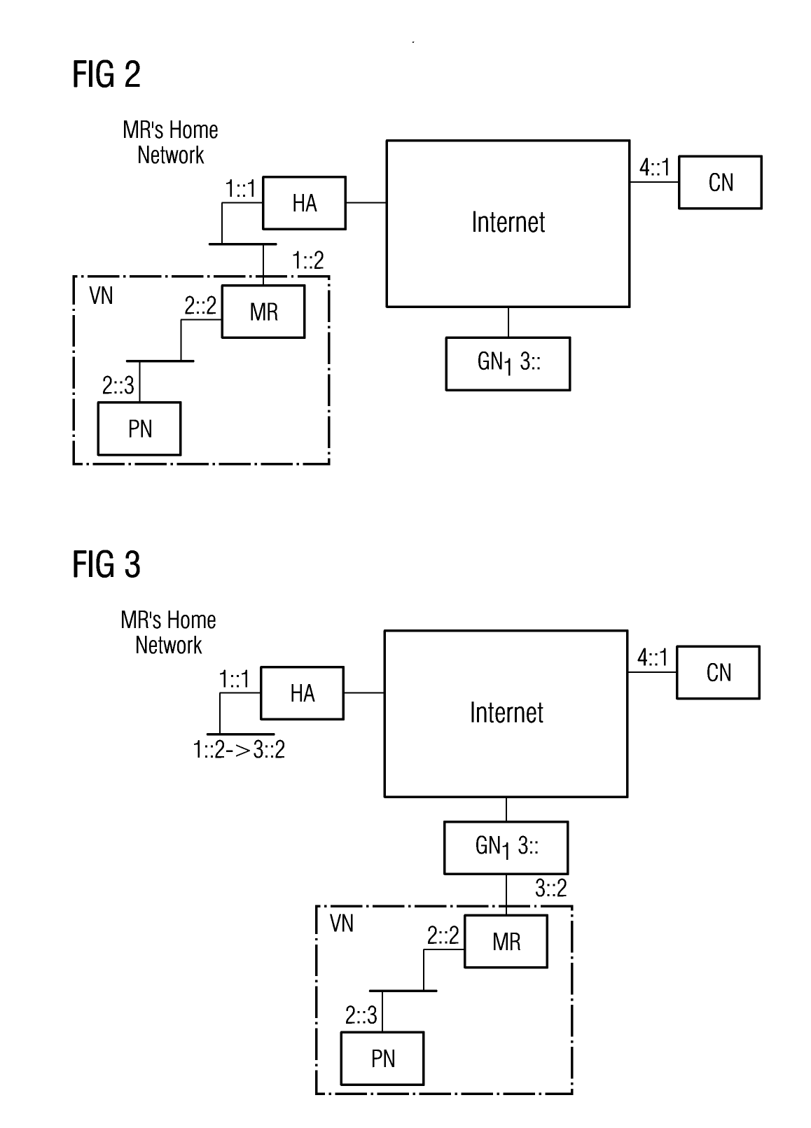

It is assumed that the HA of the MR is responsible for performing the address translation. FIG. 2 depicts the network topology where the VN is initially connected to the Internet through the MR's Home Network (this is not an essential staring point). We are using the notation x::y to represent the network id::host id elements of an IP address. Thus x:: is a network identifier, whereas x::y is host y of network x. The links connecting the nodes denote network layer connections and nothing is implied for the layer two links used. It can be recognized that the network prefix of the moving network home domain and the CoA are the same (1:: and therefore the VN is connected to its home domain).

In FIG. 3 the VN has migrated from the home network (prefix 1::) where it was originally connected to another network. After the accomplishment of the handover the MR has notified the HA of its Care-of-Address (prefix 3::) which the MR HA inserts in its binding cache, i.e. the storage which keeps mappings between home address (HoA) and temporary address (CoA). Note that when the VN changes the point of attachment, the addresses in the VN are unchanged (the network prefix for the allocated private addresses is the same, 2:: in the example). Packets destined to the MR will be tunnelled by the HA to this CoA. Moreover a bi-directional tunnel is established between the MR and the MR HA. The MR uses this tunnel as the default route for all packets generated by the PNs. As a result all packets transmitted from nodes in the VN pass though the MR's HA.

After a PN has been granted an IP address and has installed the MR as the default router, it is ready to embark communication with other nodes on the Internet. The PN will construct all IP packets in the same way as if it was in a stationary IP network and it will forward them as usual to its default router, the MR in this case. As expected, the source address field of the IP header is set to the IP address assigned to the PN from the MR and the destination address field is set to the IP address of the node with which the PN wishes to communicate.

The MR will receive the packet and it will tunnel it to its HA. Prior to the encapsulation the MR could compress the original IP packet for efficiency purposes. Reducing the upload traffic is beneficial because the available bandwidth is exploited more efficiently and also the financial cost charged from the Ground Network, GN, is reduced in cases like GPRS networks for example where traffic is charged per byte.

When the HA receives the encapsulated packet it removes the outer packet header information and forwards the packet, with additional information, to the NAT device. The additional information is used to manage the address mapping and can include for example the following information:
the MR, which routed the packet,
network policies from the operator of the MR home network domain,
user policies, specified e.g. when the PN attaches to the VN.

The NAT device then uses this information, plus information encoded within the packet header (for example the PN source address, the source and destination port identifiers) to maintain its address-mapping table. Finally, the NAT device replaces the PN source address with an address from the MR home network prefix before forwarding the packet along the next hop towards its destination. For IPv4, the checksum of the IP header must also be recalculated.

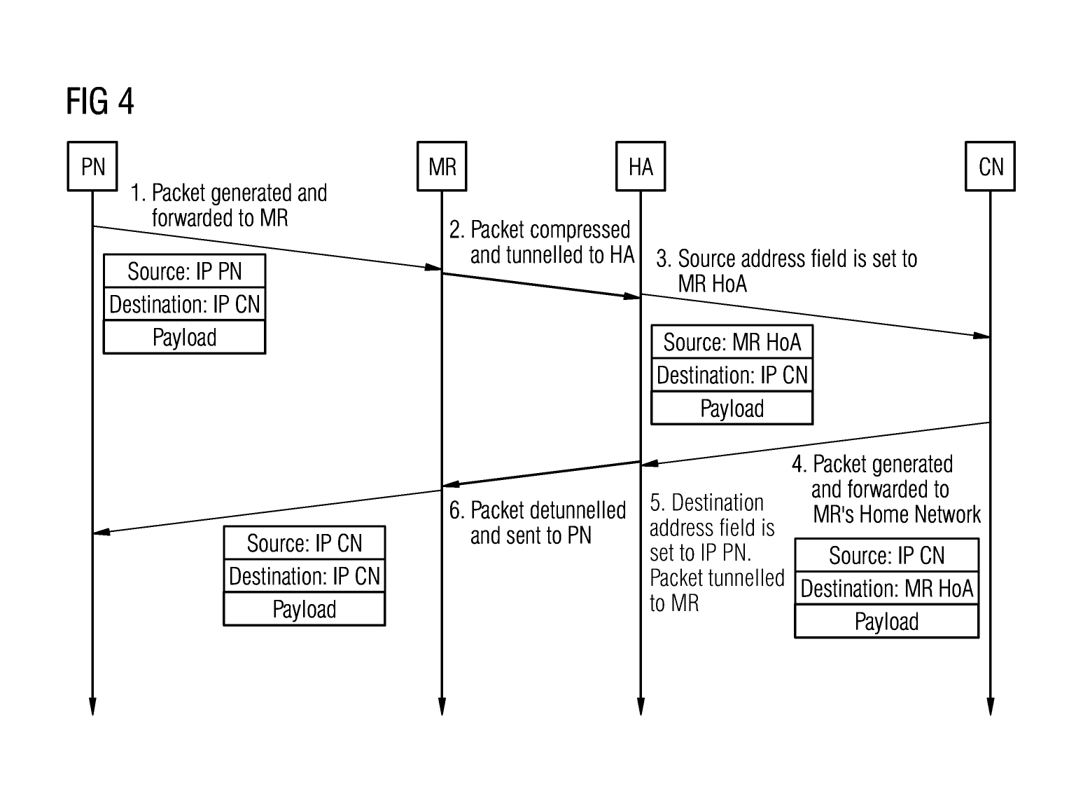

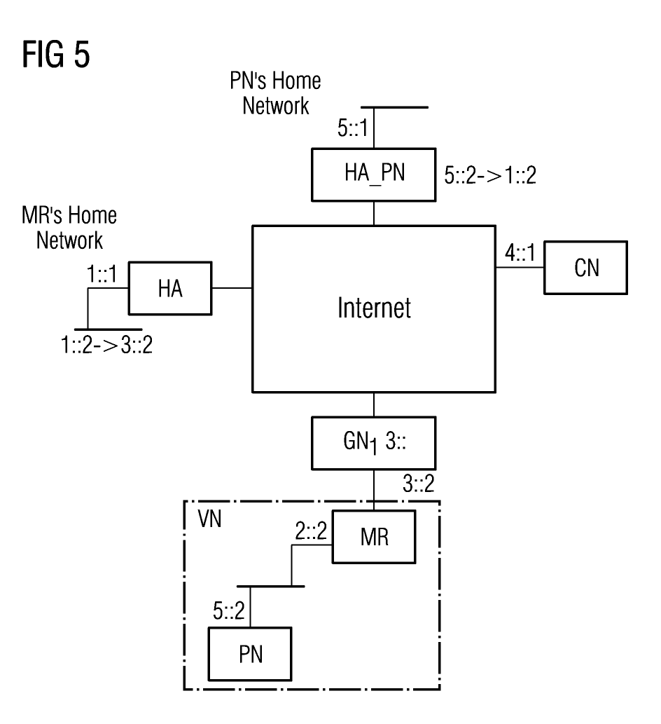

When the packet reaches the ON it appears as if the MR sent the packet from its home address since the source address field is set to the MR's HoA. As a result, response packets generated from the CN contain the MR's HoA in the destination address field, and are routed with IP routing to the MR's Home Network. Here, the NAT device captures the packets and checks the address mapping table so as to determine if reverse translation is required to the packet. If a match is found then reverse translation is required and consequently the destination address field is altered. More precisely the address allocated to the PN is used instead of the MR's HoA. After the translation, the HA tunnels the packet to the MR, using the MR's CoA as the destination address field of the outer IP packet. (How the packet reaches the HA depends upon whether the HA and NAT are an integrated device or not.) When the packet reaches the MR it is decapsulated and finally forwarded to the PN. If no entry is found to indicate that the packet should undergo translation the NAT realizes that this is a MR destined packet. The diagram in FIG. 4 shows the packet transformations through the communication path between the PN and CN. Note that the socket pair (PN source address—TCP/UDP port at PN; CN source address—TCP/UDP port at CN) is not changed at any end of the communication path and as a result the communication between PN and CN is maintained regardless of the VN's current location.

It has been described how communication is achieved between nodes in the VN and other nodes on the Internet while the VN is away from the MR's home network. The same mechanism is applied when the VN is in the home network, with the only variation being the absence of the tunnel between the MR and the HA. Outbound packets generated from the PN are forwarded to the MR and from there to the NAT without the presence of a tunnel. Translation is performed again and the packet is forwarded to the final destination with IP routing.

A key feature of the proposed method is the capability of the PNs to handover from one VN ton another, e.g. a passenger leaves a train in the station and enters another one. This can occur when both VNs are managed by the same operator, and thus both MRs are being served by the same (or coordinated) HA. Extra intelligence installed at the MR HA would enable PNs to migrate from one VN to another while keeping the same IP address, hence maintaining all active network connections. Since datagrams destined to the PN are delivered towards their destination with the aid of tunnels it is possible for a PN to move from one \IN to another and the only requirement would be for the MR HA to tunnel PN destined messages to the appropriate VN.

In the case where the PN does not change the VN, inbound traffic at the home agent can be routed based on a certain address prefix, which uniquely identifies the destination VN. If handover between different VNs should be supported, while the PN keeps the address, the destination VN can't be identified based on the address prefix of the destination address for inbound packets. Addressing is managed by a central node, the HA, so as to avoid address duplication conditions i.e. where the same IP address is assigned to more than one PN. Whilst centralized addressing affects the HA performance, it offers the advantage that every PN is identifiable by a unique IP address.

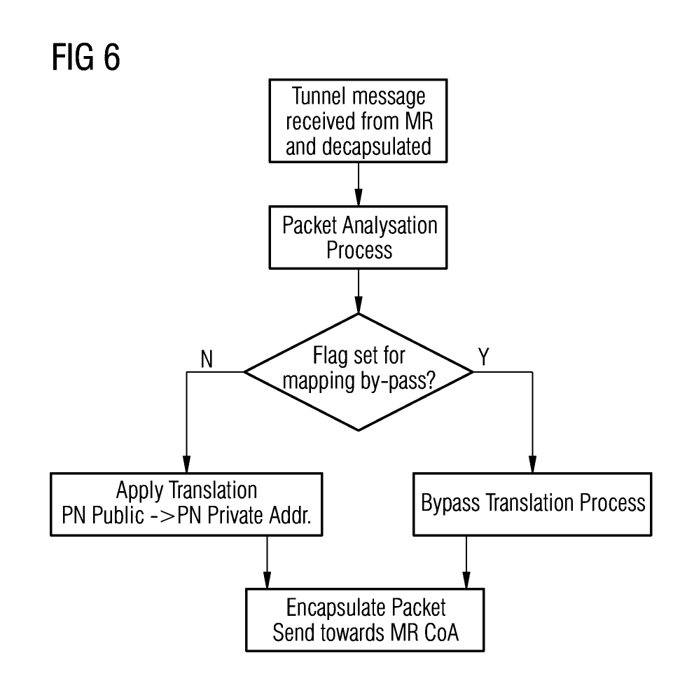

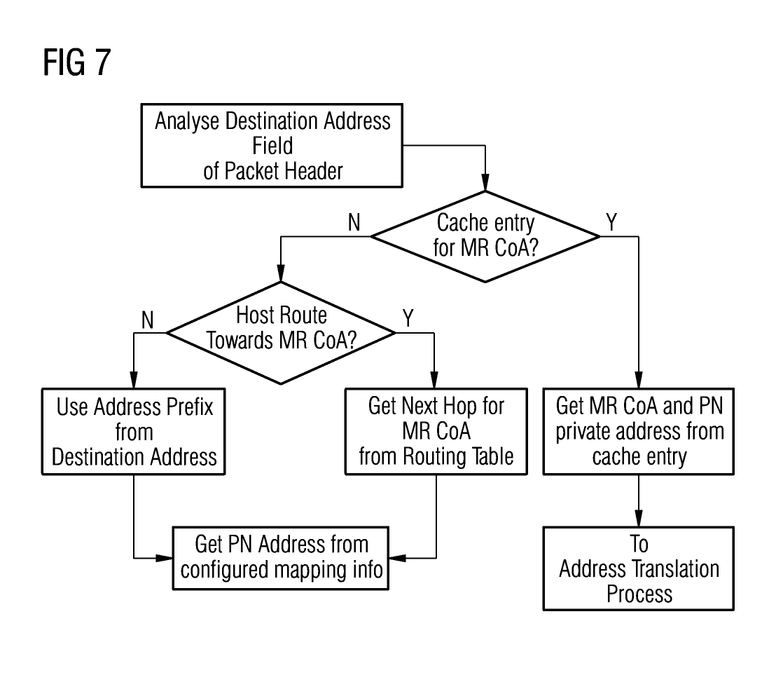

When a PN migrates to a different VN, the routing tables in the MR home network have to be updated according to the router advertisements received from the new MR. For outbound traffic, sent by the PN the mechanism for decapsulation and translation in the MR home network are the same just like for a single VN supported by the home network. When the PN sends a datagram, the packet as before is tunnelled to the HA and decapsulated. Before forwarding the packet to the destination address, i.e. the CN, the correct PN source address has to be determined, which is used for address translation. The forwarding of inbound traffic also requires additional steps at the HA compared to the situation with just single VN home networks. For inbound traffic destined for a PN, the correct VN has to be determined before address translation and packet encapsulation can take place. The shortcoming of this solution is that the HA needs to do per host instead of prefix based routing, which delays the forwarding process to some extend. This can be partly compensated if address mappings are cached based on inbound and outbound traffic as well. With this procedure handovers between different VNs have no effect on communication between the PN and the CN since the socket pair remains unchanged at both ends, As a result the PN can move around the VNs and the NAT will be responsible for keeping the same address for address translation and also for tunnelling datagrams destined to the PN to the correct VN. The flowchart of FIG. 6 summarizes the HA's functionality for inbound traffic sent towards the PN. In FIG. 7 the part of this process is illustrated, which is responsible for analyzing the packets.

However the PN may specify during the initial registration with a VN the demand for a future handover to a different VN. In this situation an address could be allocated to the PN from a special address prefix, which indicates that per host routing is required in the home network domain. Consequently if the PN would not specify its-demand for future VN handover, prefix based routing can be applied for packets destined for those PNs. Thus per host routing would be required just or those PNs, which require VN handover in the future.

In the case where the PN is enabled with mobility functionality (i.e. runs a mobility protocol and sends location update information to its home agent) some additions must be applied, because the address assigned to the PN from the MR cannot be employed with macromobility protocols as the address known to the PN may not be globally reachable. One approach to this problem, which has been adopted within the IETF NEMO working group, requires that the address assigned to a PN belongs to a subnet of the MR's home network. Then datagrams directed by the PN home agent will reach the MR's home network, and from there can be delivered to the VN. However, as in the NEMO case, the inefficiency of double tunnelling occurs.

The topologically irrelevant address problem can be surmounted if the PN registers a specific MR home address as a CoA with its home agent (PN_HA). In this case the PN_HA will forward all packets destined to the PN to this address and consequently the datagrams will be captured by the Home Agent of the MR, as shown in FIG. 5. The MR HA identifies that the datagram is a tunnel packet sent from another home agent and therefore it does not go through translation as with other packets buts the packet is tunnelled direct to the MR. The request for translation ignorance is based on the allocated PN address, which comes from a specific MR prefix.

This section contains the functions performed according to the described algorithm during a PN session. First is portrayed the scenario where the translation is executed at the HA. For outband packets:

Scenario 1: PN Registration
Step 1: The PN attaches to VN and starts with accounting process or the PN asks for a global address at any time later.
Step 2: The VN advertises network services to be offered, e.g. single address support,
   handover support to other VNs,
   support for MIP enabled PNs,
   etc.
Step 3: The PN finalizes the registration by specifying the service request.
Step 4: The MR request CoA for PN.
Step 5: HA allocates a private and a public address for the PN. The NAT device stores the address mapping for the PN and the MR is used as the default router for the PN.

Scenario 2: Translation for Outbound Traffic in MR Home Network
Step 1: The PN wishes to initiate a session with another node on the Internet. The packets are constructed and forwarded to the MR as if the PN was in a stationary network.
Step 2: The MR receives the packet and tunnels it to the HA.
Step 3: The HA de-capsulates the packet and check its list of identifiers.
Step 4: Address translation is performed, the PN private address in the source address field of the packet is replaced with an address from the prefix in the MR home network. The PN source address to be used can be determined by information, which is configured in the MR home network domain and IP header information. Additionally for IPv4 packets the checksum is recalculated.
Step 5: The HA stores the appropriate information-identifiers-for performing reverse address translation. That is the address of the PN, source port, address of the CN and destination port. The care-of address of the MR is also stored.
Step 6: The packet is forwarded to its destination.

Scenario 3: Translation for Inbound Packets in MR Home Network
Step 1: The CN sends response packets to the MR's HoA. With IP routing those packets are delivered to the MR's home network.
Step 2: Based on the network address prefix of the destination address, the destination VN and its appropriate CoA is identified.
Step 3: The HA captures the packets and performs reverse address translation according to the stored identifiers. The destination address field is replaced with the IP address of the PN and the checksum is recalculated for IPv4 packets.
Step 4: The packet is tunnelled to the MR where it is currently situated. This information is stored in the HA.
Step 5: The MR decapsulates the packet and forwards it to the PN.

Scenario 4: Handover between VNs

In the case where a PN performs a handover to another VN managed by the same operator the following steps are followed. Note that in this scenario addressing is managed by the HA thus the IP address that is assigned to the PN is unique.
Step 1: The PN migrates to another network and updates its routing table according to the router advertisements received from the new MR, i.e. now a different MR is the new default router.
Step 2: MR in the new VN sends a registration for PN and the HA updates the stored identifiers, and therefore associates the PN private and public address with a new MR.
Step 3: The PN sends IP datagrams according to the already running TCP/IP connections.
Step 4: The packet is tunnelled from the MR to the HA.
Step 5: The HA checks its cash table to verify the stored identifiers. After detecting no cache entry the HA creates a ‘new one for the identified connection.
Step 6: The HA performs address translation using the old MR's IP address for maintenance of ongoing sessions, The address of the MR where the PN is now located is also stored.
Step 7: The translated datagram is forwarded to its destination. Packets on the reverse path are processed as in the previous scenario.

Scenario 5: Packets, which By-Pass the Translation Process
Step 1: The PN registers at MR with information about its PN Home Network (PN HoA etc.).
Step 2: This information is delegated to the MR HA.
Step 3: The PN obtains an address from a special MR HA prefix, which indicates that address translation is not required PN registers this address with its home network.
Step 4: Outbound traffic is sent via MR-MR HA to the ON.
Step 5: For inbound traffic that is sent via PN HA to the MR HA it is recognized that address translation is not needed due to the special significance of the address prefix.
Step 6: The packet is encapsulated without translation and sent towards the CoA of the MR.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

### DEFINITIONS

MR: Mobile Router: the gateway device of the moving network that physically connects the moving network to the rest of the world, i.e. external networks like the Internet.
PN: Portable Node: a node that is connected to the Internet through the mobile router. There may be many PNs associated with one MR.
CN: Correspondent Node: a node within the Internet that communicates with the PN.
CoA: Care of Address: an address allocated by a visited network (i.e. a network, which is not part of the home domain associated with a user) to a node that joins it.
MIP: Mobile IP: this is a method of ensuring that mobile nodes remain reachable, by allowing them to associate a CoA with their well-known (e.g. DNS registered) home address. Basic MIP assumes that the network is fixed and only the end terminal moves.
GN: Ground Network: the network to which the MR directly physically connects.
VN: Vehicular Network: is a special instantiation of a moving network like a train or plane network providing services to the passengers. In general the term VN is mostly used in the following although the more general term “moving network” applies.
HA: Home Agent: this term comes from Mobile IP based mobility management and describes a routing component that redirects messages to the current location of a mobile node.
HoA: Home Address: an address, which is allocated by the home network domain. It can be regarded as a fixed address for a node, which has a subscription with the operator of this network domain.
NAT: Network Address Translation: address translation usually is required, if packets are routed between transport networks and private network domains, as within these private domains private addresses are often allocated to client nodes.

1-15. (canceled)

16. A method of transferring data packets from a first endpoint of a portable source belonging to a first network that is mobile to a second destination endpoint belonging to a second network that is packet oriented, where the first network may be moving relatively to the second network, comprising:
translating addresses for data packets by a home network domain of the first network, where a first address of the first endpoint is associated with a home address of the first network.

17. A method according to claim 16, wherein said translating is based on a set of identifiers used to distinguish the data packets and determine which of the addresses is used for translation.

18. A method according to claim 17, wherein said translating is further based on static configuration parameters, including at least one of address header information, user policies, network policies, state information related to a packet, and state information related to a current location of the first network.

19. A method according to claim 18, further comprising translating additional addresses for additional data packets destined to the first network, before the additional data packets are forwarded to the current location of the first network.

20. A method according to claim 19, further comprising, when the data packets are originated by the first endpoint,
forwarding the data packets to the home network domain of the first network; and
replacing, in the home network domain, a source address field with a mobile access point home address for a mobile router located in the first network and corresponding to the first endpoint.

21. A method according to claim 20, further comprising using a tunnelling mechanism which hides a private address allocated to the first endpoint from any transport network located outside the first network.

22. A method according to claim 21, wherein the home domain of the first network serves additional moving networks.

23. A method according to claim 22, further comprising assigning, by the home domain, an individual network address prefix for the first network and each additional moving network served by the home domain.

24. A method according to claim 23, further comprising obtaining the private address and a public address by the first endpoint during one of an authentication procedure and any later time.

25. A method according to claim 24, further comprising supporting a handover process from the first network to one of the additional moving networks served by the home domain of the first network by associating the first address of the first endpoint when moved to the additional moving network with a moving address of the additional moving network.

26. A method according to claim 25, further comprising:
initiating the handover process; and
sending the additional data packets to both the first network and the additional moving network until the handover process is completed.

27. A method according to claim 26, further comprising allocating to a second endpoint, which is subject to a future handover request, a second address from a specific network address prefix maintained by a moving network domain.

28. A method according to claim 27, further comprising obtaining, by a third endpoint, a third address from a network prefix with special significance which is registered with another home network domain of the third endpoint, to by-pass translating performed by the home network domain of the first endpoint.

29. A mobile access point located in a first network transferring data packets from a first endpoint of a portable source belonging to the first network that is mobile to a second destination endpoint belonging to a second network that is packet oriented, where the first network may be moving relatively to the second network, said mobile access point comprising:
means for employing a tunneling mechanism for transfer of data packets, which hides a private address allocated to the first endpoint from any transport network located outside the first network.

30. A home access point located in a home network domain of a first network transferring data packets from a first endpoint of a portable source belonging to the first network that is mobile to a second destination endpoint belonging to a second network that is packet oriented, where the first network may be moving relatively to the second network, said home access point comprising
means for translating addresses to replace a source address field with a home address of the first endpoint and vice versa.
